(19) United States
(12) Patent Application Publication
(10) Pub. No.: US 2014/0175704 A1
(43) Pub. Date: Jun. 26, 2014

(54) Draping and Compression Molding Tool and Method for Producing a Preform and a Fiber-Plastic Composite Component

(71) Applicants: Christian Eberdt, Stuttgart (DE); Simom Klumpp, Neuhausen (DE); Thomas Kolb, Holzheim (DE); Mortiz Schroeder, Eching (DE)

(72) Inventors: Christian Eberdt, Stuttgart (DE); Simom Klumpp, Neuhausen (DE); Thomas Kolb, Holzheim (DE); Mortiz Schroeder, Eching (DE)

(73) Assignee: Daimler AG, Stuttgart (DE)

(21) Appl. No.: 14/126,339

(22) PCT Filed: Dec. 16, 2011
(86) PCT No.: PCT/EP2011/006361

§ 371 Date: Jan. 29, 2014

(30) Foreign Application Priority Data
Jun. 16, 2011 (DE) 10 2011 104 366.0

(51) Int. Cl. B29C 43/36; B29C 43/52

(52) U.S. Cl. CPC B29C 43/361; B29C 43/52
USPC 264/319; 425/167

(57) ABSTRACT

A draping and molding tool to manufacture a preform is consolidated at least in sections and includes two tool halves, the surfaces of which are arranged facing one another. At least one of the tool halves includes a plurality of ram segments, which have a lifting movement, and are individually controllable and are individually moveable. The ram segments form a tool surface of the tool half.

### BACKGROUND AND SUMMARY OF THE INVENTION

Exemplary embodiments of the present invention relate to a draping and molding tool to create a preform, which is consolidated at least in sections, as well as the production method itself and, furthermore, the manufacturing of a fiber plastic composite component from the preform.

The preforming of textile primary products is know from prior art, wherein the so-called preforms are formed, which are at least close in their design to the fiber composite structures to be produced from them. Until now, this preforming has represented a step of a procedure, which requires high manual expenditure with regard to time and cost.

In order to allow a large-scale production of such preforms for the production of reinforcing sections, which are curved in at least one dimension, made from a composite material, such as, for example, an epoxy resin system reinforced with carbon fiber, German patent document DE 10 2008 042 574 B4 discloses a device to deposit and drape a plurality of web-shaped sections of a fabric, in particular of a multi-axial fiber fabric and/or of a reinforcement fabric, automatically to create a profile preform on a core through the repeated depositing and draping of the sections. By impregnating the profile preform with a plastic material, which is able to be set, in a molding tool, the reinforcement profile is obtained. Here, individual fabric layers are deposited and draped onto the mold core by means of cassettes. Meanwhile, a binder powder is spread onto each individual layer, whereupon the binder of the fabric layer stack is melted and set. The compacting is implemented by a pressing device, which is temperable by means of, for example, induction coils and cooling devices, such that the binder of the preform is set quickly. After this, the preform is removed from the tool and supplied to the molding tool, in which, according to the known RTM technology, the preform is infiltrated with resin and is set.

Taking this into account, the production process should be accelerated and the device able to be used for it universally.

Exemplary embodiments of the present invention are directed to a device, with which the production process can be accelerated, whilst, at the same time, the device should be able to be used universally.

Exemplary embodiments of the present invention are also directed to a production method for preforms or the fiber plastic composite components, which are able to be produced from them, with improved automation and thus a decrease in the portions of work that are carried out manually, such that high numbers of pieces can be achieved in a cost-effective manner.

Finally, exemplary embodiments of the present invention are directed to a method to produce a fiber plastic composite component from a preform using a draping and molding tool according to the invention.

A first embodiment relates to a draping and molding tool with two tool halves, the surfaces of which that are facing one another being formatively designed, which serves to manufacture a preform, which is consolidated at least in sections. In order now to be able to drape the fiber layers used to produce the preform, which are arranged between the halves of the tool, into shape quickly and in an automated manner, the one or also both of the tool halves thus have a plurality of ram segments, which have a lifting movement, are individually controllable and are individually moveable and form the formative tool surface of the corresponding tool half. These individually controllable and individually moveable ram segments enable an automated draping of a complete fiber layer stack and thus the device according to the invention allows a clearly quicker procedure compared to the known method, in the case of which each individual layer is draped in its own right. Furthermore, the ram segments allow the uncomplicated varying of the formative surface of the tool halves, such that differently shaped preforms can be produced in one draping and molding tool by the ram segments being controlled correspondingly.

If only one of the tool halves has the ram segments, this can be the upper tool half, which provides a positively formative tool surface, whilst the segment-free lower tool half is embodied solidly with a defined tool surface.

In order to consolidate the fiber layers, which are draped into shape and comprise a binder material, with the draping process at the same time or in real time, such that one or several sections undergo the consolidation independently of other sections, the draping and molding tool can comprise a heating device, which has a plurality of individually controllable heating elements, which are arranged in or under the tool surface of one or both tool halves, so in or under the tool surface formed by the ram segments, respectively in the ram segments. In the embodiment with a segment-free tool half, the heating elements lie in or under the tool surface of the segment-free tool half and/or also in the tool half that is embodied with the ram segments. The heating elements can also be inductors and/or hot impingement nozzles. Due to the heating of the binder material in the closed tool, further process time is saved, wherein draping, melting the binder and compacting can follow one another in an uninterrupted procedure and overlap in terms of time.

Alternatively or additionally to the heating device comprising the heating elements, the draping and molding compression device can have a heating device, which is moveable in a straight line between the tool halves in coordinated movement with the individually moveable ram segments. Thus the binder material in the fiber layers can be melted directly before the ram segments move to the fiber layers.

In order to achieve, consequently, a quicker cooling for the consolidation, the draping and molding tool can comprise a cooling device, which has nozzles, in particular air nozzles, which, for example, can be arranged in a tool half distributed over the surface thereof or can be arranged laterally.

The draping and molding tool can, furthermore, form a fixed work station or also be arranged on a robotic arm or a robotic hand as a section of a controllably moveable robotic device.

If it is provided that the draping and molding tool should, furthermore, serve as a RTM tool, in order to produce the fiber plastic composite component from the preform directly after the manufacture of the preform in the draping and molding tool, then the draping and molding tool can comprise an injection medium for a matrix-forming plastic system. Further devices, which are necessary for the RTM process, such as heating media to provide a setting temperature of the matrix-forming plastic system or media to exert a compression pressure, can additionally be integrated; however the present heating devices as well as the ram segments can also be designed to provide the setting temperature and the compression pressure.

For the embodiment of the draping and molding tool with a segment-free tool half, the draping and molding tool comprises a plurality of lower tool halves, embodied without ram segments, which are moveable in and out of the draping and molding tool. The segment-free tool halves can, furthermore, have different formative tool surfaces, which can be used in the draping and molding tool to produce differently shaped preforms or fiber plastic composite components respectively, by the ram segments of the upper tool halves being controlled correspondingly and respectively, in order to move into the corresponding position of the tool surface of the lower tool half.

The flexible and adaptive draping and molding tool can be used for the geometrical depiction of both only a positive shape, if only one tool half, in particular the upper tool, has the ram segments, and a positive and negative shape, if both tool halves have ram segments.

Finally, the ram segments, which can also have different widths and/or depths according to the complexity of the shape to be realized, are hydraulically, pneumatically or electromotively moved ram segments.

The draping and molding tool according to the invention allows for quick, flexible geometrical alterations of the formative work surface using the same ram segments, and is thus a tool for any geometry of the preform to be manufactured or of the fiber plastic composite components to be produced from it.

A further subject matter according to the invention relates to a method to create a shaped preform, which is consolidated at least in sections, using a previously described draping and molding tool according to the invention. The method comprises, first, the step of arranging the fiber layers, such as woven and non-woven fabric, mats, fleeces, knitted fabric, etc., which comprise a binder material, in particular in powder form, between the tool halves in the draping and molding tool, with at least one tool half of these two tool halves comprising ram segments, which have a lifting movement and which are individually controllable and individually moveable. The ram segments then are controlled and moved in a locally successive manner in the direction of the inserted fiber layers, wherein the fiber layers are draped as a stack by means of local pressure through the ram segments. The assumption of the draping work by the ram segments shortens the process time, wherein here a particularly good draping is achieved at the same time through the local control of the pressure process.

Thus the preform can already be obtained in its geometric representation early on in the process, wherein the geometrically determined stacking of individual reinforcement layers in the tool provides defined force transmission paths. The draping procedure is supported by wave-like or locally controlled pressures by means of the successively moving ram segments.

Before, during or after the moving of the ram segments, the heating device(s) is/are actuated, coordinated to the same, such that the fiber layer stack is at least locally heated. In particular, the fiber layer stack can be heated transversely to a longitudinal extension of the ram segments and following the draping movement carried out by the ram segments. The consolidation of the preform, which is at least in sections, results with or without additional cooling.

The local, selective heating of the draped fiber layer stack, e.g. through induction or hot air impingement, leads to locally stronger consolidation of the preform, which can be used for fixing and for handling operations, for example if the preform is transferred into an RTM mold. Flat heating, for example likewise through induction or hot air impingement, leads to flatter consolidation of the preform, which can be used for fixing and for handling operations, then, for example, by means of vacuum pads.

The obtained preform can then be transferred to an RTM tool for the production of the fiber plastic composite component, in which it is impregnated with a matrix-forming plastic, whereupon the impregnated preform is set under defined conditions, which depend on the type of matrix-forming plastic system used, and thus the fiber plastic composite component is obtained.

Alternatively, in an embodiment that is particularly sparing to tools, a draping and molding tool is used, with which the preform was manufactured by the draping and molding tool being additionally equipped with a corresponding injecting device for the matrix-forming plastic system. Then, after it has been manufactured, the preform can be left in the closed draping and molding tool and the injection of the matrix-forming plastic system and thus the impregnation of the preform with the matrix-forming plastic system can occur in the draping and molding tool. Here, required setting conditions, necessary for the respective matrix-forming plastic system, are then also provided, wherein it particularly concerns the heating of the impregnated preform to a setting temperature of the matrix-forming plastic system, and in particular using the exertion of a compression pressure by the ram segments of at least one tool half. After being left to set, the fiber plastic composite component can be de-molded. It is therefore conceivable that the end edge of the fiber plastic composite component is to more or less strongly deviate from that of the preform. This can be achieved by moveable sliders being arranged in the lower tool half, which open a cavity during the injection of the plastic matrix. It is also conceivable to provide ram moveable segments, which have a lifting movement, in place of the slider. By moving the slider or the ram segments of the lower tool half and thus, as a result of the provision of additional molding spaces, which are formed by the respective cavity, it is possible to achieve alterations of the component outline. In the same way, the ram segments of the upper tool half can also be moved by exposing an upper cavity and thus contribute to the alternation of the component shape. Particularly advantageously, it is possible, by means of this tool or method, to create completely different fiber plastic composite components with a single tool by different impact of the slider or of the ram segments, without the effort of conversion.

These and further advantages are depicted by the description below with reference to the attached figures.

### BRIEF DESCRIPTION OF THE DRAWING FIGURES

The reference to the figures in the description serves to support the description and the facilitated understanding of the subject matter. The figures are only a schematic depiction of an embodiment of the invention.

Therein is shown:

FIG. 1 a schematic sectional view from the side through a draping and molding tool according to the invention, in which the upper tool has the ram segments.

FIG. 2 a schematic sectional view from the side through a further draping and molding tool according to the invention, in which both tool halves have the ram segments.

### DETAILED DESCRIPTION

The invention relates to a method and a device to produce fiber plastic composite components, in particular components made from carbon fiber composite plastic. To accelerate the production process, a draping and molding tool according to the invention is used, which allows a high automation and thus the realization of a high number of pieces in a cost-effective manner, as are required, for example, in the production of motor vehicle components. Furthermore, the draping and molding tool is able to be used universally, i.e. to produce a plurality of different preforms or components, which are also complexly and three-dimensionally shaped.

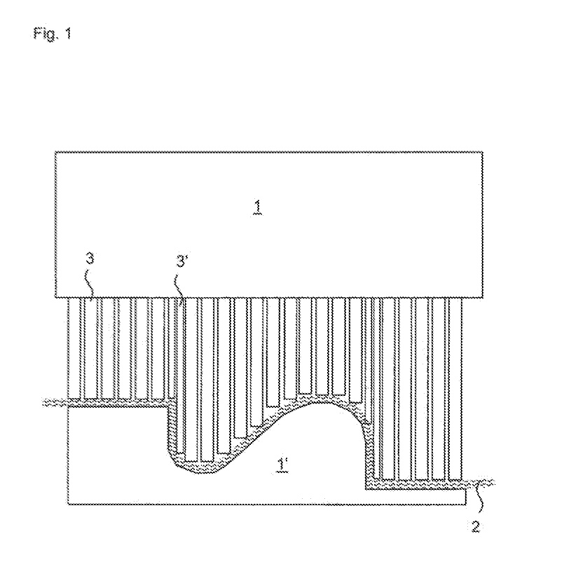

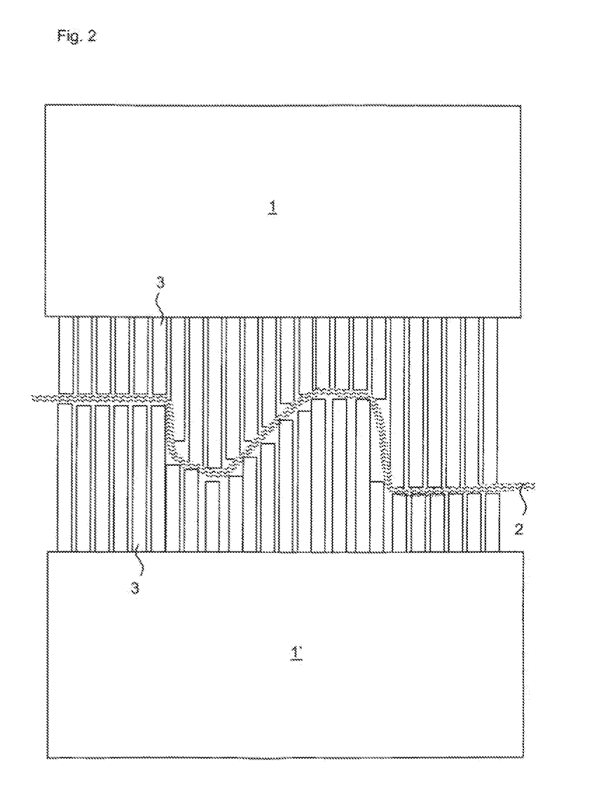

To that end, a segmented compression tool is provided with the draping and molding tool depicted in FIGS. 1 and 2, wherein in FIG. 1, only one tool half 1 has individually controllable and individually moveable ram segments 3, 3′, which have a lifting movement and can be arranged to form the formative tool surface of the tool half 1, here the positive shape, whilst the lower tool 1′ is solid and provides the negative shape with its tool surface. In FIG. 2, both the upper tool 1 and the lower tool 1′ have the individually controllable, individually moveable ram segments 3, which have a lifting movement and which are then able to be arranged to form the positive and negative formative tool surfaces respectively. The ram segments 3,3′ can preferably be hydraulically, pneumatically or electromotively actuated. As is to be seen in FIG. 1, the ram segments 3, 3′ can, furthermore, have different widths, for example in order to be able to better reproduce a complex shape. Thus, wider ram segments 3 can be provided in regions, in which the shape is even or only has a slight curve, whilst narrower segments 3′ can be used in places which have a more complex shape progression.

In the draping and molding tool, textile fiber layers such as multi-axial fiber fabric, reinforcement fabric, woven fabric, mats, fleeces, knitted fabric, etc., which preferably comprise a binder material in powder form, are introduced between the tool halves 1, 1′, whereupon the fiber layers are draped as a stack by means of local pressures through local, successive driving of the ram segments 3, 3′.

The fiber layer stack is—following the draping movement, so in the transverse direction to the longitudinal extension of the ram segments 3, 3′—heated, which allows for an optimal draping and no layer displacement through shearing due to binder material that has already melted. Optionally or depending on the shape to be depicted, the draping movement can occur from the center of the mold radially or from both sides outwards or from left to right or from right to left.

Through heating, the preform 2 is at least locally consolidated and then the tool can be removed without it losing its shape and can be supplied to an RTM tool in order to be impregnated with a resin and set in an RTM process and thus to produce the fiber plastic composite component.

Alternatively, the consolidated preform 2 can undergo the RTM method in the same tool, wherein here the lower tool 1′ should be solid, as is depicted in FIG. 1.

The heating in the draping and molding tool to consolidate the preform 2 and, if necessary, to set the fiber plastic composite component, if the RTM-step, likewise, is carried out in the draping and molding tool, can occur through heating elements, which, for example, can be arranged in a segment-free lower tool V. The heating elements are connected according to the draping movement. Alternatively, the ram segments 3, 3′ of the other tool half 1 can also be equipped with heating media. It is also conceivable that both tool halves 1,1′ are equipped with heating elements. In particular, inductors for contact heating or hot impingement nozzles for contact-free heating are possible as individually connectable heating elements, which then accordingly are constructed in or under the tool surface respectively of the respective tool half, so, if necessary, in the segments 3, 3′.

An arrangement of a heating medium that is able to move in a straight line parallel to the direction of the draping movement (in a direction of tool extension) between the tool halves over the fiber stack would also be conceivable.

A flat heating can, in particular, be carried out here, where no layer displacement of the fiber layers is to be expected.

The cooling to consolidate the fiber layer stack can occur by means of air flow, preferably by means of nozzles, which can be distributed over at least one of the tool surfaces and/or arranged laterally.

It is also conceivable to allow the heated fiber layer stack to simply stand during the consolidation of the preform 2, until it reaches a manageable temperature. Cooling devices such as the nozzles, however, accelerate the production process.

In the same way as the upper tool half 1, the lower tool half 1′ can also be segmented, as is depicted in FIG. 2. Due to the segmentation with the moveable ram segments 3, 3′, every conceivable 3D surface geometry is achievable with one single tool and very quickly in the case of the formation of flat fiber plastic composite components. The tool can be installed in a fixed manner in a work station or can also be a part of a robot arm or hand.

The draping of a fiber layer stack according to the invention can clearly be carried out more quickly than the known processes of the individual layer draping. The assumption of the draping work by the ram segments 3, 3′ further shortens the processing time, wherein here a particularly good draping is achieved through the local controlling of the pressure procedure. Due to the heating of the binder material in the closed tool, further process time is saved. Herein the draping, melting of the binder and compacting can be carried out in succession in an uninterrupted procedure, wherein the steps can overlap in terms of time. Also in the case of a local heating, the process time is, likewise, usually shortened.

If the RTM process to be carried out subsequently to produce the fiber plastic composite component occurs in the same draping and molding tool as the production of the preform 2, the number of tool components required to form a fiber plastic composite component is minimized to one single tool, wherein here the draping and molding tool has additional devices for the impregnating and setting in the tool. Here it can be, in particular, one (or several) injection device(s) for the matrix-forming plastic, for example a resin system. Further devices required for setting, as well as for tempering and for pressurization can additionally be integrated. The heating elements, however, which are designed and able to be controlled to melt the binder material to consolidate the preform 2 in such a way that they can heat the tool, and the impregnated preform 2 respectively, to a setting temperature of the respective plastic system. Furthermore, the ram segments 3, 3′ and their drive can be designed in such a way that they can exert the pressure that is provided for the setting.

The production time is optimized further still with the RTM process, which is carried out in the draping and molding tool, to produce the manufactured fiber plastic composite component. Preferably, the lower tool 1′ should then be solid, so not segmented, as is depicted in FIG. 1.

In order to accelerate the cycle time further, several lower tools 1′ can be provided, which are driven out from the complete tool after the component production, such that a lower tool 1′ loaded with a new fiber layer stack outside the draping and molding tool can be brought in, whilst the manufactured preform 2 or the fiber plastic composite component is driven out of the extraction from the draping and molding tool.

For a draping and molding tool that only has one segmented tool half 1, a plurality of differently shaped lower tools 1′ can, furthermore, be provided, which allow the production of different preforms/components in one tool, as the segmented tool half can vary in terms of the design of its formative tool surface through the controllable ram segments.

Due to the local pressure of the fiber layer stack, a special arrangement and draping of one or several fiber layers, orientated to the force transmission path of the later component, is possible, such that a fiber plastic composite component, which is tailor made to the mechanical load requirement, can be produced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof

1-9. (canceled)

10. A draping and molding tool for manufacturing a preform, comprising:
two tool halves, the surfaces of which are facing one another, which is consolidated at least in sections,
wherein at least one of the tool halves comprises a plurality of ram segments, which are configured to have a lifting movement and which are individually controllable and individually moveable, said ram segments forming a tool surface of the tool half and having different widths, depths, or are actuated hydraulically, pneumatically or electromotively.

11. The draping and molding tool according to claim 10, wherein the at least one tool half comprising the ram segments is a positively formative tool surface.

12. The draping and molding tool according to claim 10, wherein the draping and molding tool further comprises:
at least one heating device, which has a plurality of individually controllable heating elements in the form of inductors or hot impingement nozzles, wherein the heating elements are arranged in or under a tool surface of at least one of the tool halves and are moveable in a straight line in coordinated movement with the individually moveable ram segments.

13. The draping and molding tool according to claim 10, wherein the draping and molding tool comprises a cooling device having air nozzles.

14. The draping and molding tool according to claim 10, wherein the draping and molding tool is a fixed work station or is arranged as a section of a controllably moveable robotic device.

15. The draping and molding tool according to claim 10, wherein the draping and molding tool comprises an injection medium for a matrix-forming plastic system.

16. The draping and molding tool according to claim 10, wherein the draping and molding tool comprises a plurality of lower tool halves, which do not include ram segments, wherein the tool halves
are moveable into and out of the draping and molding tool, or
have different formative tool surfaces.

17. A method to create a preform, which is molded and consolidated at least in sections, using a draping and molding tool comprising two tool halves, the surfaces of which are facing one another, which is consolidated at least in sections, the method comprising:
arranging fiber layers comprising a binder material between the tool halves in the draping and molding tool, of the two tool halves, at least one tool half of whose two tool halves comprises ram segments, which have a lifting movement, are individually controllable and are individually moveable; and
controlling the ram segments and local successive movement of the ram segments in a direction of the inserted fiber layers and therein draping of the fiber layers as a stack by means of local pressure.

18. The method according to claim 17, comprising the steps:
actuating the at least one heating device and at least local heating of the fiber layer stack, coordinated to the movement of the ram segments by heating of the fiber layer stack transversely to a longitudinal extension of the ram segments following the draping movement; and
consolidating the preform at least in sections, with or without cooling.

19. A method to produce a fiber plastic composite component from a preform using a draping and molding tool comprising two tool halves, the surfaces of which are facing one another, which is consolidated at least in sections, the method comprising:
manufacturing a preform by
arranging fiber layers comprising a binder material between the tool halves in the draping and molding tool, of the two tool halves, at least one tool half of whose two tool halves comprises ram segments, which have a lifting movement, are individually controllable and are individually moveable; and
controlling the ram segments and local successive movement of the ram segments in a direction of the inserted fiber layers and therein draping of the fiber layers as a stack by means of local pressure
injecting a matrix-forming plastic system and impregnating of the preform, left in the closed draping and molding tool, with the matrix-forming plastic system;
preparing setting conditions for the matrix-forming plastic system by heating of the impregnated preform to a setting temperature of the matrix-forming plastic system and by exerting a compression pressure through the ram segments of the at least one tool half; and
setting and demolding the fiber plastic composite component.
